(19) United States
(12) Patent Application Publication
(10) Pub. No.: US 2010/0051443 A1
(43) Pub. Date: Mar. 4, 2010

(54) HETERODIMERIC SYSTEM FOR VISIBLE-LIGHT HARVESTING PHOTOCATALYSTS

(76) Inventor: Kwangyeol Lee, Namyangju-si (KR)

Correspondence Address: EDWARDS ANGELL PALMER & DODGE LLP, P.O. BOX 55874, BOSTON, MA, 02205, US

(21) Appl. No.: 12/202,079

(22) Filed: Aug. 29, 2008

(51) Int. Cl. B01J 20/06

(52) U.S. Cl. 204/157.15; 502/350; 502/4; 502/352

(57) ABSTRACT

Heterodimeric photocatalytic systems and methods of making and using the same are disclosed. The systems can include a first nanomaterial comprising titanium dioxide (TiO₂) having a first bandgap energy characterized by a first highest occupied molecular orbital (HOMO) and a first lowest unoccupied molecular orbital (LUMO). The systems can further include a second nanomaterial comprising semiconducting metal oxide and/or metal sulfide (MO_{X}/MS_{X}) having a second bandgap characterized by a second HOMO and a second LUMO, wherein the second bandgap energy is in the range of energies for a visible light spectrum, and the second LUMO is higher than the first LUMO.

### BACKGROUND

### Description of the Related Technology

Photocatalysis refers to the acceleration of a photoreaction in the presence of a catalyst. In photocatalysis, the photocatalytic activity (PCA) depends on the ability of the catalyst to create electron-hole pairs, which generate free radicals (hydroxyl ions; OH—) able to undergo secondary reactions. Titanium dioxide (TiO₂) is a known semiconductor material for its photocatalytic activity. Examples of applications for photocatalysis based on TiO₂ include water electrolysis and water treatment by oxidation of organic matter by free radicals generated from TiO₂.

TiO₂ is only UV light responsive. That is, TiO₂ requires ultraviolet rays having a wavelength 400 nm or less (3.2 eV or greater) as the excitation light. Meanwhile, solar light contains visible light in addition to the UV rays. Visible light is composed of photons in the energy range of around 2 to 3 eV. TiO₂, when used as a photocatalyst, is not responsive to the visible light, and thus uses only a fraction of radiation spectrum arriving from the sun. More intense light in the visible-light range simply remains unused in a TiO₂-based photocatalytic system.

TiO₂ nanostructures might be designed to be coated with certain dyes (organic and inorganic compounds), which harvest photons in the visible light and transfers the elevated electron to the lowest unoccupied molecular orbital (LUMO) of the TiO₂ structures. The colored dyes can be dissociated from the TiO₂ surface, thereby causing dye-induced contamination.

### SUMMARY

In some aspects, there can be photocatalytic systems using heterodimers. The heterodimers can include a first nanomaterial that includes titanium dioxide (TiO₂) having a first bandgap energy characterized by a first highest occupied molecular orbital (HOMO) and a first lowest unoccupied molecular orbital (LUMO). The heterodimers can further include a second nanomaterial comprising semiconducting metal oxide and/or metal sulfide (MO_{X}/MS_{X}) having a second bandgap energy characterized by a second HOMO and a second LUMO. The second bandgap energy can be in the range of energies for a visible light spectrum, and the second LUMO is higher than the first LUMO.

In other aspects, there can be methods of harvesting visible light for photocatalysis that can include providing a heterodimer comprising a first nanomaterial comprising titanium dioxide (TiO₂), and a second nanomaterial comprising semiconducting metal oxide and/or semiconducting metal sulfide (MO_{X}/MS_{X}). The methods can further include exposing the heterodimer to electromagnetic (EM) radiation. At least part of the visible light spectrum of the EM radiation can be absorbed by the second nanomaterial to excite an electron from a highest occupied molecular orbital (HOMO) to a lowest unoccupied molecular orbital (LUMO) of the second nanomaterial.

In other aspects, there can be methods of fabricating a heterodimeric photocatalytic (HDP) structure which methods can include impregnating a host matrix with a second nanomaterial comprising semiconducting metal oxide and/or metal sulfide (MO_{X}/MS_{X}) whose bandgap energy can be in the range of energies for visible light spectrum. The methods can further include coating a first nanomaterial comprising TiO₂ onto at least part of the surface of the impregnated host matrix.

In other aspects, there can be methods of fabricating a heterodimeric photocatalytic (HDP) structure that can include forming a heterodimer comprising a first nanomaterial comprising titanium dioxide (TiO₂), and a second nanomaterial comprising semiconducting metal oxide or metal sulfide (MO_{X}/MS_{X}) nanomaterial whose bandgap energy is in the range of energies for visible light spectrum. The methods can further include impregnating the heterodimer into a host matrix.

In other aspects, there can be photocatalytic systems that include photocatalytic heterodimers. The heterodimers can include an ultraviolet (UV) light responsive nanomaterial. The heterodimers can further include a visible light responsive nanomaterial. The UV light responsive material and the visible light responsive nanomaterial can be attached to or proximally positioned with respect to each other such that a photogenerated electron from the visible light responsive nanomaterial can transfer to the UV light responsive nanomaterial to participate in a photocatalytic activity.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 shows an electronic energy diagram of a semiconductor such as TiO₂.

FIG. 2A shows a diagram that illustrates an example electron transfer process involving a heterodimeric photocatalytic (HDP) system a TiO₂ nanomaterial and an adjacent undoped semiconducting oxide (MO_{X}) nanomaterial.

FIG. 2B shows a diagram that illustrates an example electron transfer process involving a heterodimeric photocatalytic (HDP) system a TiO₂ nanomaterial and an adjacent doped semiconducting oxide (MO_{X}) nanomaterial.

FIG. 3 shows an example photocatalytic process that generates free radicals by a heterodimeric photocatalytic (HDP) system based on a heterodimer comprising a TiO₂ nanomaterial and an adjacent visible-light-responsive MO_{X}/MS_{X} nanomaterial.

FIG. 4A shows a composite structure comprising a host matrix impregnated with MO_{X}/MS_{X} nanomaterials.

FIG. 4B shows an example heterodimeric photocatalytic (HDP) structure, e.g., HDP sheet, comprising TiO₂ nanomaterials attached to the outer surface of the composite structure shown in FIG. 4A.

FIG. 5 shows an example of a roll processing system that can be used for fabricating a heterodimeric photocatalytic (HDP) sheet.

FIG. 6 shows a series of pictorial diagrams for illustrating an example process for fabricating a heterodimeric photocatalytic (HDP) structure comprising photocatalytic heterodimers integrated with a host matrix.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to photocatalytic systems.

Aspects of the present disclosure relate to photocatalytic systems that can harvest visible light spectrum for photocatalysis. The photocatalytic systems can include heterodimers having a first nanomaterial that includes titanium dioxide (TiO₂), and one or more second nanomaterials that include semiconducting metal oxides and/or semiconducting metal sulfides (MO_{X}/MS_{X}) whose bandgap energies are in the range of the energies for the visible spectrum of light.

Charge separation in nanomaterials can occur when they are subject to a photon-induced bandgap excitation. The photogenerated electrons and holes are capable of oxidizing or reducing the adsorbed substrates and/or promoting a photocatalytic reaction by acting as a mediator for the charge transfer between two adsorbed molecules. Due to its large bandgap energy (3.2 eV), TiO₂ photocatalyst requires UV-excitation, e.g., UV ray having a wavelength of 400 nm or less, to induce charge separation within the particle. Consequently, a majority of the energy spectrum of the incident sunlight is lost or not used, resulting in a low photocatalytic activity (PCA).

The PCA of the TiO₂-based photocatalytic system can be improved, however, by forming a heterodimeric photocatalytic (HDP) system that includes, for example, TiO₂ nanomaterial and a nanomaterial of semiconducting metal oxides (MO_{X}) and/or semiconducting metal sulfides (MSx) (which will be henceforth be referred to as “MO_{X}/MS_{X} nanomaterial”) attached or positioned adjacent to the TiO₂ nanomaterial. The MO_{X}/MSx nanomaterial can absorb some of the visible light that would be otherwise lost by the TiO₂ nanomaterial and creates an electron-hole pair by elevating an electron from a valence band to a conduction band. The elevated electron can be transferred to the adjacent TiO₂ nanomaterial in the HDP system.

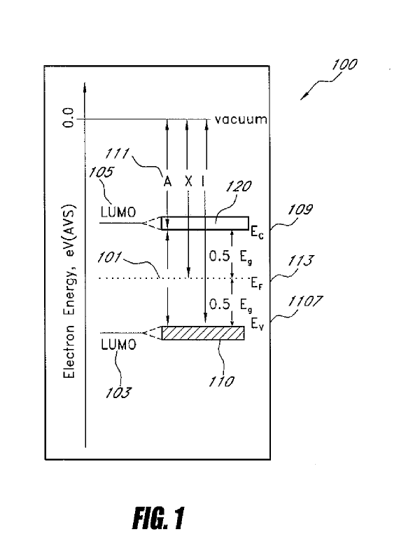

FIG. 1 shows an electronic energy diagram 100 of a semiconductor material such as TiO₂. A brief review of the electronic band structure of semiconductors and bandgap energies and conduction edge energies of various semiconducting metal oxides and metal sulfides is given in American Mineralogist, Vol. 85, pp. 543-556, 2000, which is incorporated herein by reference in its entirety. The electronic structure of semiconductors is characterized by the presence of a bandgap (E_{g}) 101, which represents an energy interval with very few electronic states (i.e., with low density of states) between a valence band 110 and a conduction band 120, which both include a high density of states. In the context of electron transfer between semiconductors and aqueous redox species, it can be advantageous to identify the highest occupied molecular orbital (HOMO) energy level 103 and the lowest unoccupied molecular orbital (LUMO) energy level 105 in the semiconductor because those are the energy levels involved in the transfer. In most semiconductors, electronic levels involved in the valence band 110 are occupied whereas the levels in the conduction band 120 are empty. Hence, the HOMO level 103 coincides with the top of the valence band 110.

The energy of valence band edge, E_{V}, 107 is a measure of the ionization potential, I, of the bulk material. The LUMO energy level 105 in most semiconductors coincides with the bottom of the conduction band 120. The energy of the conduction band edge, E_{C}, 109 is a measure of the electron affinity, A, 111 of the compound. The Fermi level or energy, E_{F}, 113 represents the chemical potential of electrons in a semiconductor. Incorporation of impurities, also called dopants, in the structure of a semiconductor can lead to the presence of electron acceptor state levels and/or donor levels within the bandgap 101. The presence of donor or acceptor levels change the position of E_{F} so that E_{F} lies just above E_{V} for p-type semiconductors (presence of acceptor states) and E_{F} lies just below E_{C} for n-type semiconductors (presence of donor states). More importantly for the systems and methods described herein, doping can reduce the bandgap energy of the semiconductor to which the dopants are added.

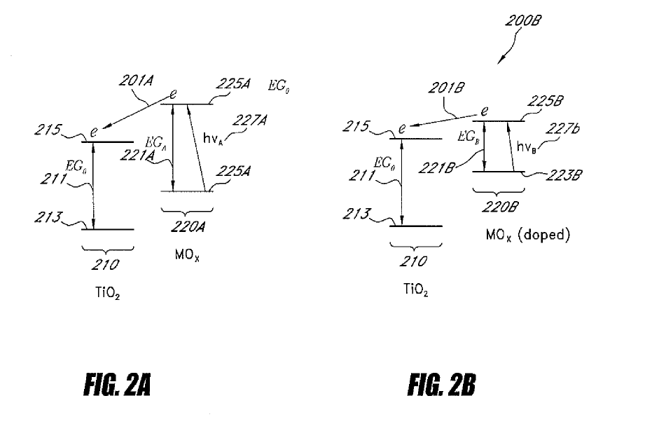

FIG. 2A shows a diagram that illustrates an example electron transfer process involving a heterodimeric photocatalytic (HDP) system including a TiO₂ nanomaterial 210 and an adjacent undoped semiconducting oxide (MO_{X}) nanomaterial 220A. The TiO₂ nanomaterial 210 has an energy gap (Eg₀) 211, and the undoped MO_{X} nanomaterial has an energy gap (Eg_{A}) 221A. The Ego 211 is characterized by a HOMO 213 and a LUMO 215, and the Eg_{A} 221A is characterized by HOMO 223A and LUMO 225A.

A photon of energy hv_{A} 227A elevates an electron from the HOMO 223A to the LUMO 225A, thereby creating a charge separation (an electron-hole pair) in the undoped MO_{X} nanomaterial 220A. The elevated electron can then moves from the LUMO 225A of the undoped MO_{X} nanomaterial to the LUMO 215 of the adjacent TiO₂ nanomaterial via an electron transfer process 201A. For the electron transfer process 201A to occur freely, the LUMO level 225A is higher than the LUMO level 215, and the Ego 211 and the Eg_{A} 221A are comparable to each other, e.g., within 0.5 eV. The bandgap energy (Eg₀) of TiO₂ is 3.20 eV, and the conduction band edge (E_{C0}), which relates to the position of the LUMO 215, is −4.21 eV (more negative, the lower the LUMO). Table 1 lists bandgap energies (E_{VA}) and conduction band edges (E_{CA}) of some semiconducting metal oxides (MO_{X}) whose LUMO is higher than the LUMO 215 of TiO₂ (e.g., whose E_{CA} is less negative than −4.21 eV).

TABLE 1
Semiconducting metal oxides having E_{CA} > −4.21 eV

| MO_{X} | Eg_{A} (eV) | E_{CA} (eV) |
|---|---|---|
| AlTiO₃ | 3.60 | −3.64 |
| Ce₂O₃ | 2.40 | −4.00 |
| Cr₂O₃ | 3.50 | −3.93 |
| Ga₂O₃ | 4.80 | −2.95 |
| In₂O₃ | 2.80 | −3.88 |
| KnBO₃ | 3.30 | −3.64 |
| KTaO₃ | 3.50 | −3.57 |
| La₂O₃ | 5.50 | −2.53 |
| LaTi₂O₇ | 4.00 | −3.90 |
| LiNbO | 3.50 | −3.77 |
| LiTaO₃ | 4.00 | −3.55 |
| MgTiO₃ | 3.70 | −3.75 |
| MnO | 3.60 | −3.49 |
| MnTiO₃ | 3.10 | −4.04 |
| Nd₂O₃ | 4.70 | −2.87 |
| NiO | 3.50 | −4.00 |
| PbO | 2.80 | −4.02 |
| Pr₂O₃ | 3.90 | −3.24 |
| Sm₂O₃ | 4.40 | −3.07 |
| SnO | 4.20 | −3.59 |
| SrTiO₃ | 3.40 | −3.24 |
| Tb₂O₃ | 3.80 | −3.44 |
| Yb₂O₃ | 4.90 | −3.02 |
| ZnO | 3.20 | −4.19 |
| ZrO₂ | 5.00 | −3.41 |

Since the visible light is composed of photons in the energy range of about 2 to about 3 eV, it is generally desirable to select a MO_{X} material whose bandgap energy is in the middle of the range or about 2.5 electron volts (eV). However, the material selection can be affected by other factors such as the conversion efficiency (a measure of the probability of the photoexcitation given a photon of energy greater than the bandgap energy), the cost of the materials, and environmental factors such as toxicity (which can prevent the use of a metal oxide containing Hg, Pb, or Cd). An example of a MO_{X} that can be used given these considerations includes Ce₂O₃ (Eg_{A}=2.40 eV).

As data from Table 1 show, bandgap energies for many semiconducting metal oxides are greater than 3.21 eV, the bandgap energy for the TiO₂ nanomaterial. Examples of such metal oxides are NiO (Eg_{A}=3.50 eV) and SnO (Eg_{A}=4.20 eV). Even for those MO_{X} materials whose bandgap energies are less than 3.21 eV, many of their bandgap energies are close to 3.21 eV. Examples of such metal oxides are MnTiO₃ (Eg_{A}=3.10 eV) and ZnO (Eg_{A}=3.20 eV). If these nanomaterials are used, much of the visible spectrum of the solar radiation (generally 2-3 eV) still would not be harvested by the HDP system 200A because only photons in the UV range can participate in the charge separation in the MO_{X}. Direct doping of the TiO₂ nanomaterials may reduce its bandgap energy towards the energies for the visible light spectrum, but the direct doping may not be desirable because it can cause a deterioration in the TiO₂ quality and thus in the photocatalytic performance (PCA).

A way to utilize such relatively large bandgap MO_{X} materials (some of which may have high conversion efficiencies) to harvest a greater proportion of the visible light spectrum is to dope the MO_{X} nanomaterial component of the photocatalytic to tune its bandgap energy to fall within the range of energies for the visible light spectrum. FIG. 2B shows a diagram that illustrates an example electron transfer process involving a heterodimeric photocatalytic (HDP) system 200B including a TiO₂ nanomaterial 210 and an adjacent doped semiconducting oxide (MO_{X}) nanomaterial 220B. The doping results in a doped bandgap energy (Eg_{B}) 221B that is lower than the undoped bandgap energy 221A (FIG. 2A). Dopants that can be used include carbon and halides, for example. Carbon can come from carbon-containing polymers such as polycarbonsilane melt during a heat-based decomposition. Halides can be deposited by plasma implantation. Alternatively, different metals can be introduced to produce defect sites by adding small amounts of metal salts containing the different metal during the fabrication of MO_{X} nanomaterials. In certain embodiments, the doped bandgap energy (Eg_{B}) 221B is less than 3.21 eV, the bandgap energy (Eg₀) 210 for the TiO2 nanomaterial. In some of such embodiments, the doped bandgap energy (Eg_{B}) 221B is in the range of energies for the visible light spectrum, e.g., 2-3 eV.

When the PDP system 200B is exposed to EM radiation, e.g., sunlight or an artificial light, a photon carrying an energy hv_{B} 227B can elevate an electron from the HOMO 223B to the LUMO 225B, thereby creating a charge separation (an electron-hole pair) in the undoped MO_{X} nanomaterial 220B. The elevated electron then moves from the LUMO 225B of the doped MO_{X} nanomaterial 220B to the LUMO 215 of the adjacent TiO₂ nanomaterial via an electron transfer process 201B. Suppose in the HDP system 200B, the MO_{X} nanomaterial 220B is doped to such a degree that the Eg_{B} 221B is within the range of energies for visible light spectrum (e.g., 2-3 eV). In that case, the electron transfer 201B can be initiated by a photon in the visible light spectrum, permitting participation of the photons in the visible spectrum in the photocatalytic process and, thereby, increasing the photocatalytic activity (PCA) for the HDP system 200B. Accordingly, the HDP system 200B having a properly doped MO_{X} nanomaterial can achieve a greater PCA than its undoped counterpart by better harvesting the visible spectrum of the incident EM radiation, e.g., sunlight. To maximize the PCA, the MO_{X} can be doped so that its bandgap energy is at or near the region of highest intensity of the solar spectrum.

In some embodiments, the MO_{X} nanomaterial may include a combination of two or more different semiconducting metal oxides that cover different ranges of energy bands in the visible light spectrum. In some of such embodiments, one or more the two or more different semiconducting metal oxide materials may be doped.

In other embodiments, semiconducting metal sulfides (MS_{X}) can be used in lieu of, in combination with, or in addition to doped or undoped semiconducting metal oxides (MO_{X}). Table 2 lists bandgap energies and conduction band edges of some semiconducting metal sulfides (MS_{X}) whose LUMO is higher than the LUMO of TiO₂ (e.g., whose E_{CB} is less negative than −3.21 eV).

TABLE 2
Semiconducting metal sulfides having E_{CB} > −4.21 eV

| MS_{X} | Eg_{A} (eV) | E_{CB} (eV) |
|---|---|---|
| Ce₂S₃ | 2.10 | −3.59 |
| CuInS₂ | 1.50 | −4.06 |
| CuIn₅S₈ | 1.26 | −4.09 |
| Dy₂S₃ | 2.85 | −3.36 |
| Gd₂S₃ | 2.55 | −3.57 |
| In₂S₃ | 2.00 | −3.70 |
| La₂S₃ | 2.91 | −3.25 |
| MnS | 3.00 | −3.31 |
| Nd₂S₃ | 2.70 | −3.30 |
| Pr₂S₃ | 2.40 | −3.43 |
| Sm₂S₃ | 2.60 | −3.39 |
| Tb₂S₃ | 2.50 | −3.51 |
| T₁AsS₂ | 1.80 | −4.16 |
| ZnS | 3.60 | −3.46 |
| Zn₃In₂S₆ | 2.81 | −3.59 |

As can be seen from Table 2, some semiconducting metal sulfides (MS_{X}), such as Ce₂S₃, Gd₂S₃, Nd₂S₃, Pr₂S₃, Sm₂S₃, Tb₂S₃, Zn₃In₂S₆, have bandgap energies within the range of energies for the visible light spectrum (e.g., 2-3 eV), and, thus, can be used without doping. Alternatively, a higher bandgap MSx material, such as MnS or ZnS, may be used after the material is doped to tune its bandgap energy to fall within the range of energies for the visible light spectrum.

In some embodiments, the MS_{X} nanomaterial may include a combination of two or more different semiconducting metal sulfides that cover different ranges of energy bands in the visible light spectrum. In some of such embodiments, one or more the two or more different semiconducting metal oxide sulfides may be doped. In other embodiments, a combination of MO_{X} and MO_{X} nanomaterials may be employed to harvest the visible light spectrum.

It should be appreciated that the TiO₂ nanomaterials and the MO_{X}/MS_{X} nanomaterials of various embodiments can be in various forms including nanoparticles, nanorods, nanowires, nanoclusters, nanoplates, and the like. The semiconducting metallic oxides or sulfides can be formed of various metals including a metal such as Ag, Al, Au, Ba, Bi, Cd, Ce, Co, Cr, Cu, Dy, Fe, Ga, Hf, Hg, In, K, La, Li, Mg, Mn, Nb, Nd, Ni, Os, Pb, Pd, Pr, Rh, Ru, Sb, Sm, Sn, Sr, Ta, Tb, Ti, Tl, V, W, Yb, Y, Zn, Zr, and the like. The metal oxides or sulfides can include binary or ternary systems. The characteristic dimensions (e.g., diameter and length) of the TiO₂ and/or MO_{X}/MS_{X} nanomaterials can be in the range of 0.1-500 nm.

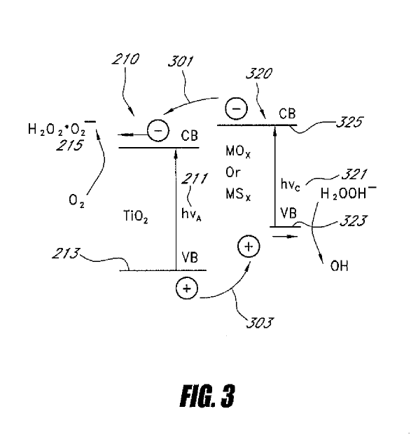

FIG. 3 shows an example photocatalytic process that generates free radicals by a heterodimeric photocatalytic (HDP) system 300. The system 300 includes a heterodimer including a TiO₂ nanomaterial 210 and an adjacent visible-light-responsive (VLS) MO_{X}/MS_{X} nanomaterial 320. Such heterodimeric photocatalytic (HDP) system can be immersed in water (H2O) and subjected to incident EM radiation, e.g., sunlight. The MO_{X}/MS_{X} nanomaterial 320 can be selected or engineered (e.g., doped) such that it is responsive to visible light. That is, a photon of the visible light spectrum can create an electron-hole pair in the material In certain embodiments, the visible-light-responsive (VLR) MO_{X}/MS_{X} nanomaterial 320 can include an undoped semiconducting metal oxide (MO_{X}) nanomaterial such as Ce₂O₃ or In₂O₃ whose bandgap energy falls within the range of energies for the visible light spectrum (e.g., 2-3 eV). In other embodiments, the visible light responsive MO_{X}/MS_{X} nanomaterial 320 includes a doped MO_{X} nanomaterial whose bandgap energy is tuned to fall within the range of energies for the visible light spectrum by the virtue of doping. In yet other embodiments, the visible light responsive MO_{X}/MS_{X} nanomaterial 320 can include an undoped semiconducting metal sulfide (MS_{X}) such as Ce₂S₃, Gd₂S₃, Nd₂S₃, Pr₂S₃, Sm₂S₃, Tb₂S₃, or Zn₃In₂S₆ whose bandgap energy falls within the range of energies for the visible light spectrum. In yet other embodiments, the visible light responsive MS_{X} nanomaterial can include a doped MS_{X} nanomaterial includes a doped MO_{X} nanomaterial whose bandgap energy is tuned to fall within the range of energies for the visible light spectrum by the virtue of doping.

A photon of energy hv_{C} 321 in the visible light spectrum elevates an electron from a valence band at LUMO 323 to a conduction band at LUMO 325 in the MO_{X}/MS_{X} nanomaterial 320, thereby creating an electron-hole pair. Meanwhile, a photon of energy hv_{A} 211 in the UV light spectrum elevates an electron from a valence band at LUMO 213 to a conduction band at LUMO 215 in the TiO₂ nanomaterial 210 thereby creating another electron-hole pair. The elevated electron at the LUMO 325 moves to the LUMO 215 of the adjacent TiO₂ nanomaterial 210 via an electron transfer process 301. The hole created at the HOMO 213 of the TiO₂ nanomaterial 210 can move to the HOMO 323 of the adjacent MO_{X}/MS_{X} nanomaterial 320 via a hole transfer process 303. The electrons at the LUMO 215 and the holes at the HOMO 323 can be used to generate free radicals, e.g., OH—, and O₂+ ions in the water.

The rate of photogenerated charge (electron and hole) transfers, hence, the photocatalytic activity (PCA) of a HDP system can decrease as a function of the relative separation between the component materials of the heterodimer. For example, the PCA of the HDP system 300 would decrease as the average distance between the MO_{X}/MS_{X} nanomaterial component and the TiO₂ nanomaterial component of the heterodimer increases. Therefore, to achieve a high PCA, it can be desirable to have a closely-held HDP system in which the MO_{X}/MS_{X} nanomaterial is held in close proximity to the TiO₂ nanomaterial so that the electron transfer process 301 and the hole transfer process 303 can freely take place between the dual components (FIG. 3). In some embodiments, the dual components are attached to each other. In some non-attached embodiments, the average distance between the dual components can be in the range of 1-1,000 nm. In some of such embodiments, the average distance can be in the range of 1-10 nm. In yet other embodiments, the average distance can be in the range of 10-100 nm. In yet other embodiments, the average distance can be in the range of 100-1000 nm. As used herein to describe certain embodiments, “heterodimer” refers to a combination of TiO2 and MO_{X}/MS_{X} nanomaterials, where the TiO₂ component is attached to or proximally positioned with respect to the MO_{X}/MS_{X} component such that a charge transfer process (e.g., the electron transfer process 301) can take freely place.

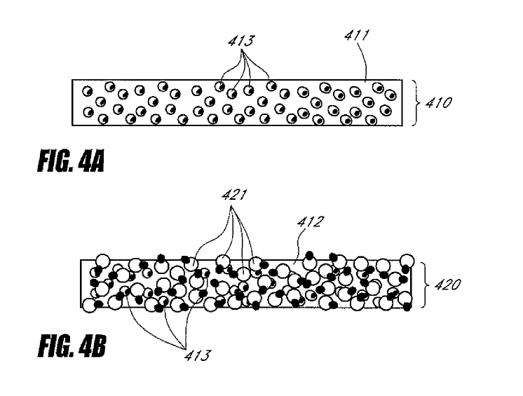

In certain embodiments, the MO_{X}/MS_{X} nanomaterials are embedded in, added to, dispersed on, deposited on, formed with, or otherwise impregnated into a host matrix, e.g., a polymer film. FIGS. 4A and 4B show diagrams illustrating an example process for fabricating heterodimeric photocatalytic (HDP) structures 410 and 420 including TiO₂ nanomaterials and MO_{X}/MS_{X} nanomaterials, wherein the MO_{X}/MS_{X} nanomaterials are impregnated into a host matrix. FIG. 4A shows a composite structure 410 including a host matrix 411 impregnated with MOx/MS_{X} nanomaterials 413. The MOx/MS_{X} nanomaterials 413 can be semiconducting metal oxides or metal sulfides and can be either doped or undoped. In some embodiments, the MOx/MS_{X} nanomaterials 413 are selected or engineered such that the materials are responsive to visible light. That is to say, the MOx/MS_{X} nanomaterials 413 can be selected or made to have bandgap energies in the range Of energies for the visible light spectrum. In the example embodiment shown, the host matrix 411 can be a polymer film and the resulting composite structure 410 is a composite film.

In some embodiments, the polymer film 411 includes, for example, a carbon-based polymer such as polycarbosilane. In other embodiments, the polymer film 411 can include, for example, silicone, polysilane, polystannane, polyphosphazene, or a combination thereof The MO_{X}/MS_{X} nanomaterials 413 can be impregnated into a host matrix (e.g., the polymer film 411) in a variety of different ways including adding a precursor solution of the nanomaterials or the nanomaterials themselves to the polymer film 411, e.g., by soaking, blending, coating, prior to curing. When the composite film 410 including the polymer film 411 impregnated with MO_{X}/MS_{X} nanomaterials or a precursor thereof is heated above a curing temperature, the composite film 411 turns into an integrated structure 412 with at least some of the impregnated MO_{X}/MS_{X} nanomaterials 413 attached on or exposed to the outer surface. In some embodiments, the polymer film 411 includes polycarbosilane. The MO_{X}/MS_{X} nanomaterials 413 can be dispersed in a polycarbosilane melt as the polymer is heated. The heating process converts the polycarbosilane into either silica (silicon dioxide) or silicon carbide materials depending on the ambient conditions. In some cases, the process produces a mesh of silica or silicon carbide nanofibers impregnated with the MO_{X}/MS_{X} nanomaterials 413. Alternatively, a solution containing the MOx/MS_{X} nanomaterials 413 can be deposited, e.g., spray coated, onto the polymer film. Other methods of integrating the MOx/MS_{X} nanomaterials 413 with a polymer film include, but not limited to: 1) in-situ polymerization of resins of the host polymer in a solvent in the presence of the nanomaterials, 2) mixing of the nanomaterials with the resin of the host polymer in a solvent, and 3) mixing solubilized nanomaterial with a host polymer melt.

FIG. 4B shows an example heterodimeric photocatalytic (HDP) structure 420 including TiO₂ nanomaterials 421 attached to the outer surface of the composite structure 410 which includes impregnated MOx/MS_{X} nanomaterials 413 as described above with respect to FIG. 4A. In the example shown, the HDP structure 420 is a HDP sheet including TiO₂ nanomaterials 420 attached to top, bottom or both surfaces of the composite film 410. The HDP structure 420 can be fabricated from the composite film 410 by coating a TiO₂ precursor solution onto the composite film 410. One way to prepare the TiO₂ precursor solution is to dissolve PVP (homopolymer, MW=1 300 000, Acros) and Ti(OBu)4 (Beijing Chemical Co.) in the mixture of ethanol/acetic acid (4:1, v:v, Beijing Chemical Co.) by stirring for 6 hours to obtain a homogeneous TiO₂ precursor solution containing 7 wt % PVP and 20 wt % Ti(OBu)₄.

The precursor coating methods can include immersing the composite film 410 in the TiO₂ precursor solution or spray coating the precursor solution onto the composite film 410. The TiO₂ precursor coated on the composite polymer film then can be subjected to a thermal treatment, e.g., by passing the composite polymer film through an oven, a furnace or an infrared lamp to form the HDP sheet 420 including the TiO₂ nanomaterials 421 attached to the surface of the composite polymer film 410 as shown in FIG. 4B. The resulting HDP sheet 420 can be used as a filter in a water filtration or remediation system for breaking down organic contaminants, for example.

While the example host matrix 411 shown in FIGS. 4A and 4B is based on a polymer film, many other types of host matrix materials are possible including a glass, paper, and the like. The host matrix can also be a bulk material rather than a film. The bulk material may be a porous material having a high surface-area-to-volume ratio. Such porous materials can include fibrous porous materials (FPM). While FIG. 4B shows a PDP structure where TiO₂ nanomaterials are formed outside a host matrix impregnated with MO_{X}/MS_{X} nanomaterials, other embodiments can have a PDP structure where MO_{X}/MS_{X} nanomaterials are formed outside a host matrix impregnated with TiO₂ nanomaterials.

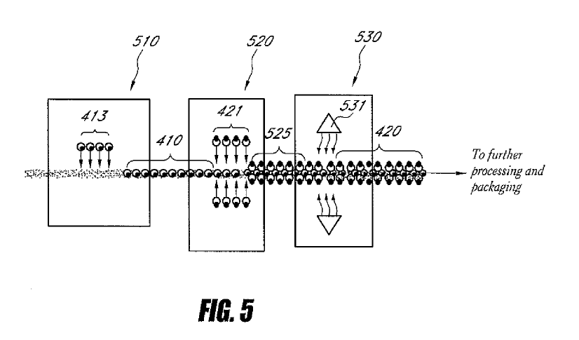

The HDP sheet 420 described above is suitable for a continuous processing system 500 such as schematically shown in FIG. 5. The continuous processing system 500 can include several sub-stations including an impregnation station 510, a coating station 520, and a thermal treatment station 530. In the impregnation station 510, a polymer film 411 is impregnated with MO_{X}/MS_{X} nanomaterials 413 to produce a composite film 410 such as shown in and described above with respect to FIG. 4A. As used herein, the impregnation includes, but not is limited to, introduction, dispersion, infusion, instillation, deposition, coating, integration, spraying of nanomaterials onto or into the host matrix. The impregnated MO_{X}/MS_{X} nanomaterials 413 can be attached to or otherwise disposed on the surface of the host matrix, or can be fully or partially integrated into or covered by the host matrix material. The polymer film 411 in its pre-impregnated state can be brought in from outside the impregnation station 510 or formed with the MO_{X}/MS_{X} nanomaterials 413 from raw materials, e.g., resins, in the impregnation station 510 itself.

The composite film 410 then is then transferred to the coating station 520, where the entering composite film 410 is coated with a TiO₂ precursor. The coating process can include, for example, passing the composite film 410 through a liquid bath of TiO₂ precursor solution. Also, the TiO₂ precursor can be coated, e.g., spray coated, onto one or both sides of the composite film 410.

The TiO₂ precursor-coated composite film 525 is then made to pass through a thermal treatment station 530, where the precursor coating is subjected to a thermal treatment to form the HDP sheet 420. In one embodiment, the thermal treatment is provided by heat sources such as an infrared lamp 531 or an oven or a furnace (not shown). The thermal treatment process converts the precursor into TiO₂ nanomaterials and can make the nanomaterials to adhere to the composite film. The HDP sheet 420 can then be subjected to further processing and packaging processes such as being wound into a roll or cut into individual filters, as necessary.

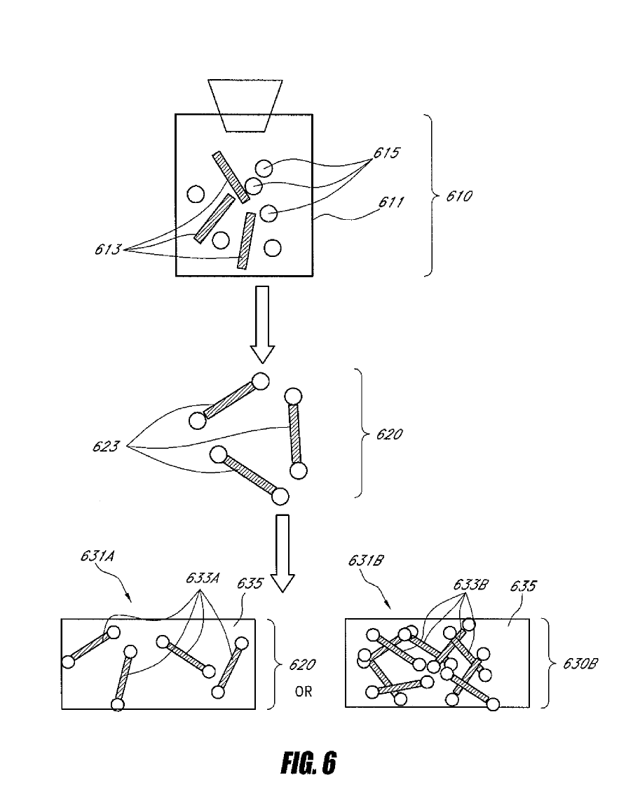

In some embodiments, TiO₂ nanomaterials and MO_{X}/MS_{X} nanomaterials can be combined (e.g., mixed, blended, attached, held together, etc.), and the heterodimers formed from the combination can be added to or deposited on a host matrix, e.g., a polymer film or a plastic or glass substrate. FIG. 6 shows a series of pictorial diagrams 610, 620, 630A, 630B for illustrating an example process for fabricating a heterodimeric photocatalytic (HDP) structure 631A, 631B including heterodimers 623 integrated with a host matrix. In the example shown, each of the heterodimers includes a TiO₂ nanomaterial 613 and one or more MO_{X}/MS_{X} nanomaterials 615. It should be understood that the pictorial diagrams of FIG. 6 are for illustration purpose only. For example, in particular, the diagrams are not drawn to scale.

In certain embodiments, the MO_{X}/MS_{X} nanomaterials 615 can be doped or undoped. In some embodiments, the MO_{X}/MS_{X} nanomaterials 615 (doped or undoped) are sensitive to visible light by having bandgap energies in the range of energies for the visible light spectrum. The first pictorial diagram 610 illustrates an example process for fabricating heterodimers 623 by combining TiO₂ nanomaterials 613 with MO_{X}/MS_{X} nanomaterials 615 in a reaction container or chamber 611. In the illustrated example, the TiO₂ nanomaterials 613 are TiO₂ nanorods, and the MO_{X}/MS_{X} nanomaterials 615 are nanoparticles. In one embodiment, TiO₂ nanorods and MO_{X}/MS_{X} nanomaterials are put into a reaction container or chamber 611 with water (H2O), and the mixture is heated to a temperature of about 100 degrees C. for 24 hours, for example. Ends of certain nanorods, e.g., TiO₂ nanorods, are known to attract other nanomaterials. The attractive force provides a mechanism for anchoring or attaching the MO_{X}/MS_{X} nanoparticles 615 to the distal ends of the TiO₂ nanorods to form the heterodimers 623 shown in the second pictorial diagram 620.

The heterodimers 623 thus formed are added or applied to a host matrix 635 to form a heterodimeric photocatalytic (HDP) structure 631A, 631B as shown in the third and fourth pictorial diagrams 630A, 630B. The difference between the HDP structure 631A and the HDP structure 631B is that in the HDP structure 631A, the heterodimer density and/or the fabrication method are chosen such that its heterodimers 633A are largely separated from each other, whereas in the HDP structure 631B, the heterodimer density and/or the fabrication method are chosen such that its heterodimers 633B are largely overlapping heterodimers.

In some embodiments of the HDP structure 631B, fibers of the heterodimers 633B can be formed by an electrospinning method. An example electrospinning method and materials are described in NANO LETTERS, 2007 Vol. 7, No. 4, 1081-1085 which is incorporated by reference in its entirety. In some embodiments, the host matrix 635 can be a polymer film. The polymer film can be any suitable material, including, for example, the carbon-based or silicon-based films discussed above with respect to FIGS. 4A and 4B. In other embodiments, the host matrix can be a polymer melt to which the heterodimers 633A, 633B are added along with a SiO₂ precursor. The host matrix 635 with the heterodimers 633A, 633B added thereto is then subjected to a thermal treatment for integrating the heterodimers 633A, 633B with the host matrix.

While the illustrated example shows a heterodimer including one TiO₂ nanorod and two MO_{X}/MS_{X} nanomaterials 615, it should be appreciated that a multitude of other configurations are possible. For example, the heterodimer can include one TiO₂ nanoparticle and one MO_{X}/MS_{X} nanoparticle. Alternatively, the heterodimer can include a TiO₂ nanowire and a plurality of MO_{X}/MS_{X} nanoparticles strung along the TiO₂ nanowire. In yet other alternative embodiments, the heterodimer can include one MO_{X}/MS_{X} nanomaterial and two or more TiO₂ nanomaterials. In some of the embodiments, the heterodimer can include one MO_{X}/MS_{X} nanorod and two TiO₂ nanoparticles.

It shall be also appreciated that the heterodimeric photocatalytic (HDP) structure 631A, 631B described above with respect to FIG. 6 is also suitable for a continuous processing system.

Furthermore, while various embodiments described so far have focused on TiO₂ nanomaterials as the UV responsive component of the photocatalytic heterodimer, it shall be appreciated that various other UV responsive nanomaterials having a high photocatalytic activity (PCA) can be used in place of the TiO₂ nanomaterial. Such high PCA UV responsive nanomaterials include ZnO or SnO. Such alternative high PCA UV responsive nanomaterials can be combined with various visible-light-responsive nanomaterials including various embodiments of MO_{X}/MS_{X} nanomaterials described herein to provide a photocatalytic heterodimers that have enhanced PCA characteristics via the utilization of the visible spectrum of the incident light.

Various embodiments of the heterodimeric photocatalytic (HDP) system described herein can be used in various applications including water electrolysis to produce H₂ gas for a hydrogen cars, for example, and treatment/filtration of contaminated water by oxidation of organic matter by free radicals generated from the HDP system.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A photocatalytic system comprising a heterodimer comprising:
a first nanomaterial comprising titanium dioxide (TiO₂) having a first bandgap energy characterized by a first highest occupied molecular orbital (HOMO) and a first lowest unoccupied molecular orbital (LUMO); and
a second nanomaterial comprising semiconducting metal oxide and/or metal sulfide (MO_{X}/MS_{X}) having a second bandgap energy characterized by a second HOMO and a second LUMO,
wherein
the second bandgap energy is in the range of energies for a visible light spectrum, and
the second LUMO is higher than the first LUMO.

2. The system of claim 1, wherein the second bandgap energy is greater than about 2 eV.

3. The system of claim 1, wherein the second bandgap energy is less than 3.21 eV.

4. The system of claim 1, wherein the second bandgap energy is at or near the wavelength of highest intensity of the solar spectrum.

5. The system of claim 1, wherein the second nanomaterial includes an undoped metal oxide.

6. The system of claim 1, wherein the second nanomaterial includes a doped metal oxide.

7. The system of claim 1, wherein the second nanomaterial includes an undoped metal sulfide.

8. The system of claim 1, wherein the second nanomaterial includes a doped metal sulfide.

9. The system of claim 1, wherein the second nanomaterial includes a combination of a doped or undoped metal oxide and a doped or undoped metal sulfide.

10. The system of claim 1, wherein the second nanomaterial includes a metal selected from a group consisting of Ag, Al, Au, Ba, Bi, Cd, Ce, Co, Cr, Cu, Dy, Fe, Ga, Hf, Hg, In, K, La, Li, Mg, Mn, Nb, Nd, Ni, Os, Pb, Pd, Pr, Rh, Ru, Sb, Sm, Sn, Sr, Ta, Tb, Ti, Tl, V, W, Yb, Y, Zn, and Zr.

11. The system of claim 1, wherein the first nanomaterial includes nanoparticles, nanorods, nanowires, or nanoplates.

12. The system of claim 1, wherein the second nanomaterial includes nanoparticles, nanorods, nanowires, nanoplates, or a combination thereof.

13. The system of claim 1, further comprising a host matrix to which at least one component of the heterodimer is added.

14. The system of claim 13, wherein the host matrix comprise a polymer film.

15. The system of claim 14, wherein the polymer film comprises polycarbosilane.

16. The system of claim 14, wherein the polymer film comprises silicone, polysilane, polystannane, polyphosphazene, or a combination thereof.

17. A method of harvesting visible light for photocatalysis, the method comprising:
providing a heterodimer comprising:
a first nanomaterial comprising titanium dioxide (TiO₂), and
a second nanomaterial comprising semiconducting metal oxide and/or semiconducting metal sulfide (MO_{X}/MS_{X}); and
exposing the heterodimer to electromagnetic (EM) radiation, wherein:
at least part of visible light spectrum of the EM radiation is absorbed by the second nanomaterial to excite an electron from a highest occupied molecular orbital (HOMO) to a lowest unoccupied molecular orbital (LUMO) of the second nanomaterial.

18. The method of claim 17, wherein the heterodimer comprises the first nanomaterial and the second nanomaterial attached to each other.

19. The method of claim 17, wherein the heterodimer comprises the first nanomaterial and the second nanomaterial positioned proximally with respect to each other such that an average spacing between the nanomaterials is in the range of 1 nm to 1000 nm.

20. The method of claim 17, wherein the excited electron transfers from the LUMO of the first nanomaterial to LUMO of the second nanomaterial.

21. The method of claim 18, wherein the transferred electron is used to generate free radicals in water.

22. The method of claim 17, further comprising providing a host matrix wherein at least one component of the heterodimer is impregnated into the host matrix.

23. A method of fabricating a heterodimeric photocatalytic (HDP) structure, the method comprising:
impregnating a host matrix with a second nanomaterial comprising semiconducting metal oxide and/or metal sulfide (MO_{X}/MS_{X}) whose bandgap energy is in the range of energies for visible light spectrum; and
coating a first nanomaterial comprising TiO₂ onto at least part of the surface of an integrated structure comprising the second nanomaterial.

24. The method of claim 23, wherein the impregnated second nanomaterial is disposed on the surface of the host matrix.

25. The method of claim 23, wherein the impregnated second nanomaterial is at least partially integrated into the host matrix.

26. The method of claim 23 wherein the impregnating comprises adding a precursor solution of the second nanomaterial to the host matrix followed by curing.

27. The method of claim 23, further comprising applying heat to the host matrix impregnated with the second nanomaterial, thereby turning the host matrix into the integrated structure.

28. The method of claim 27, wherein the integrated structure comprises silica.

29. The method of claim 23, wherein the host matrix comprise polycarbosilane.

30. A method of fabricating a heterodimeric photocatalytic (HDP) structure, the method comprising:
forming a heterodimer comprising:
a first nanomaterial comprising titanium dioxide (TiO₂), and
a second nanomaterial comprising semiconducting metal oxide or metal sulfide (MO_{X}/MS_{X}) nanomaterial whose bandgap energy is in the range of energies for visible light spectrum; and
impregnating the heterodimer into a host matrix.

31. The method of claim 30, wherein the first nanomaterial comprises a TiO₂ nanorod having two distal ends and the second nanomaterial comprises two metal oxide nanoparticles attached to the TiO₂ nanorod at or near the two distal ends.

32. The method of claim 30, wherein the first nanomaterial comprises a TiO₂ nanoparticle and the second nanomaterial comprises a metal oxide nanoparticle attached to the TiO₂ nanoparticle.

33. The method of claim 30, wherein the first nanomaterial comprises a TiO₂ nanorod having two distal ends and the second nanomaterial comprises two metal sulfide nanoparticles attached to the TiO₂ nanorod at or near the two distal ends.

34. The method of claim 30, wherein the first nanomaterial comprises a TiO₂ nanoparticle and the second nanomaterial comprises a metal sulfide nanoparticle attached to the TiO₂ nanoparticle.

35. The method of claim 30, wherein the host matrix comprise a polymer film.

36. The method of claim 30, wherein the impregnated heterodimer is disposed on the surface of the host matrix.

37. The method of claim 30, wherein the impregnated heterodimer is at least partially integrated into the host matrix.

38. A photocatalytic system comprising a photocatalytic heterodimer comprising:
a ultraviolet (UV) light responsive nanomaterial; and
a visible light responsive nanomaterial, wherein the UV light responsive material and the visible light responsive nanomaterial are attached to or proximally positioned with respect to each other such that a photogenerated electron from the visible light responsive nanomaterial can transfer to the UV light responsive nanomaterial to participate in a photocatalytic activity.

39. The system of claim 38, wherein the UV light responsive nanomaterial comprises TiO₂.

40. The system of claim 38, wherein the UV light responsive nanomaterial comprises a ZnO and/or SnO nanomaterial.

41. A water filtration system that comprises the photocatalytic system of claim 38.

42. A water electrolysis system that comprises the photocatalytic system of claim 38.
